(19) United States
(12) Patent Application Publication
(10) Pub. No.: US 2025/0301455 A1
(43) Pub. Date: Sep. 25, 2025

(54) QUALITY OF SERVICE ENHANCEMENTS FOR WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US); Bilal Sadiq, Plano, TX (US)

(21) Appl. No.: 19/070,238

(22) Filed: Mar. 4, 2025

Related U.S. Application Data
(60) Provisional application No. 63/567,239, filed on Mar. 19, 2024.
(60) Provisional application No. 63/569,007, filed on Mar. 22, 2024.
(60) Provisional application No. 63/744,019, filed on Jan. 10, 2025.
(60) Provisional application No. 63/745,087, filed on Jan. 14, 2025.

(51) Int. Cl. H04W 72/0446; H04W 28/24

(52) U.S. Cl. CPC H04W 72/0446; H04W 28/24

(57) ABSTRACT

An embodiment includes an access point (AP) may transmit a trigger frame to a station (STA) to inform the STA about AP's intention to procure frames belonging to a particular stream for which a quality of service (QOS) has been setup, where the trigger frame can carry information about which stream's frames the AP intends to procure from the STA, which can help meet the QoS requirements for traffic within the wireless network, improving communication between devices within the network.

### CROSS-REFERENCE TO RELATED APPLICATIONS

This application claims the benefit of priority from U.S. Provisional Application No. 63/567,239, entitled “TRIGGER FRAME DESIGN FOR NEXT GENERATION WLANS” filed Mar. 19, 2024; U.S. Provisional Application No. 63/569,007, entitled “IN NETWORK FLOW HANDLING FOR NEXT GENERATION WLANS” filed Mar. 22, 2024; U.S. Provisional Application No. 63/744,019, entitled “TRIGGER FRAME DESIGN FOR NEXT GENERATION WLANS” filed Jan. 10, 2025; and U.S. Provisional Application No. 63/745,087, entitled “IN NETWORK FLOW HANDLING FOR NEXT GENERATION WLANS” filed Jan. 14, 2025, which are all incorporated herein by reference in their entireties.

### TECHNICAL FIELD

This disclosure relates generally to a wireless communication system, and more particularly to, for example, but not limited to, quality of service (QOS) enhancements for wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure an access point (AP) in a wireless network, the AP comprising: a memory; and a processor coupled to the memory. The processor is configured to: transmit, to a station (STA), a first frame that indicates a preferred frame for the STA to transmit in response to the first frame. The processor is configured to receive, from the STA, a second frame that is the preferred frame in response to the first frame.

In some embodiments, the preferred frame belongs to a particular stream associated with an established quality of service (QOS).

In some embodiments, the QoS is established for the STA based on a request received from another STA.

In some embodiments, the preferred frame is associated with a traffic identifier (TID) or a stream classification service identifier.

In some embodiments, the preferred frame is associated with a traffic identifier (TID) that satisfies a lowest TID requirement or a highest TID requirement for the preferred frame.

In some embodiments, the first frame includes information indicating that the first frame includes information on the preferred frames for the STA to transmit in response to the first frame.

In some embodiments, the first frame includes information indicating whether the first frame includes a traffic identifier or a stream classification service identifier.

In some embodiments, the processor is further configured to receive, from the STA, a third frame that includes a QoS information element that includes information associated with a delay tolerance for traffic between the STA and another STA associated with the AP; and wherein the first frame is transmitted to meet the delay tolerance.

One aspect of the present disclosure provides a station (STA) in a wireless network, the STA comprising: a memory; and a processor coupled to the memory. The processor is configured to receive, from an access point (AP), a first frame that indicates a preferred frame for the STA to transmit in response to the first frame. The processor is configured to transmit, to the AP, a second frame that is the preferred frame in response to the first frame.

In some embodiments, the preferred frame belongs to a particular stream associated with an established quality of service (QOS).

In some embodiments, the QoS is established for the STA based on a request transmitted to the AP from another STA.

In some embodiments, the preferred frame is associated with a traffic identifier (TID) or a stream classification service identifier.

In some embodiments, the preferred frame is associated with a traffic identifier (TID) that satisfies a lowest TID requirement or a highest TID requirement for the preferred frame.

In some embodiments, the first frame includes information indicating that the first frame includes information on the preferred frames for the STA to transmit in response to the first frame.

In some embodiments, the first frame includes information indicating whether the first frame includes a traffic identifier or a stream classification service identifier.

In some embodiments, the processor is further configured to transmit, to the AP, a third frame that includes a QoS information element that includes information associated with a delay tolerance for traffic between the STA and another STA associated with the AP; and wherein the second frame is transmitted to meet the delay tolerance.

One aspect of the present disclosure provides computer-implemented method for wireless communication by an access point (AP) in a wireless network. The method comprises transmitting, to a station (STA), a first frame that indicates a preferred frame for the STA to transmit in response to the first frame. The method comprises receiving, from the STA, a second frame that is the preferred frame in response to the first frame.

In some embodiments, the preferred frame belongs to a particular stream associated with an established quality of service (QOS).

In some embodiments, the QoS is established for the STA based on a request received from another STA.

In some embodiments, the preferred frame is associated with a traffic identifier (TID) or a stream classification service identifier.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates end to end communication in a same basic service set (BSS) of a wireless network in accordance with an embodiment.

FIG. 5 illustrates a flow chart of an example process by an AP of transmitting a trigger frame to meet a QoS requirement in accordance with an embodiment.

FIG. 6 illustrates a flow chart of an example process by an AP when a QoS has been setup for a device by another device in accordance with an embodiment.

FIG. 7 illustrates a flow chart of an example process by an STA of receiving a trigger frame in accordance with an embodiment.

FIG. 8 illustrates a flow chart of an example process by an STA transmitting urgent traffic in accordance with an embodiment.

FIG. 9 illustrates a flow chart of an example process by an STA of receiving a trigger frame in accordance with an embodiment.

FIG. 10 illustrates an example traffic identifier indication in a trigger frame in accordance with an embodiment.

FIG. 11 illustrates a trigger frame with a preferred indication bit in accordance with an embodiment.

FIG. 12 illustrates a trigger frame with an indication of presence of modified user info field in accordance with an embodiment.

FIG. 13 illustrates a trigger frame with an indication in a modified trigger dependent user info subfield in accordance with an embodiment.

FIG. 14 illustrates a trigger frame that includes a stream classification service identifier (SCSID) in a modified trigger dependent user info field in accordance with an embodiment.

FIG. 15 illustrates a trigger frame that includes an SCSID indication in modified trigger dependent user info subfield in accordance with an embodiment.

FIG. 16 illustrates a trigger frame that includes an SCSID and traffic identifier (TID) indication in accordance with an embodiment.

FIG. 17 illustrates a trigger frame that includes a field used to indicate SCSID and TID in accordance with an embodiment.

FIG. 18 illustrates an example for triggering based on preferred indication in accordance with an embodiment.

FIG. 19 illustrates an example for triggering based on preferred indication in accordance with an embodiment.

FIG. 20 illustrates an example for triggering based on preferred indication in accordance with an embodiment.

FIG. 21 illustrates a flow chart of an example process by an STA for transmitting a QoS information element to an AP in accordance with an embodiment.

FIG. 22 illustrates a flow chart of an example process by an AP for setting up a QoS information element from an STA in accordance with an embodiment.

FIG. 23 illustrates a flow chart of an example process by an AP for a downlink QoS installation procedure in accordance with an embodiment.

FIG. 24 illustrates a flow chart of an example process by an AP for uplink QoS installation in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

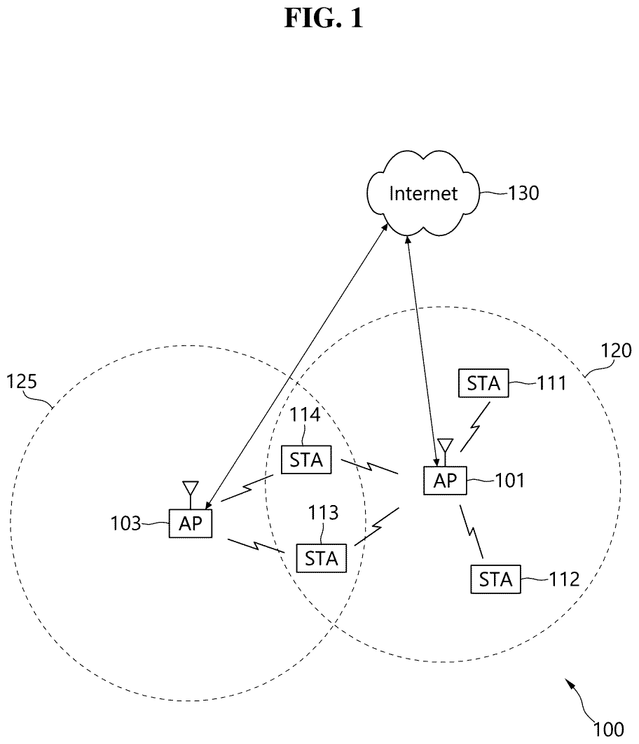

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

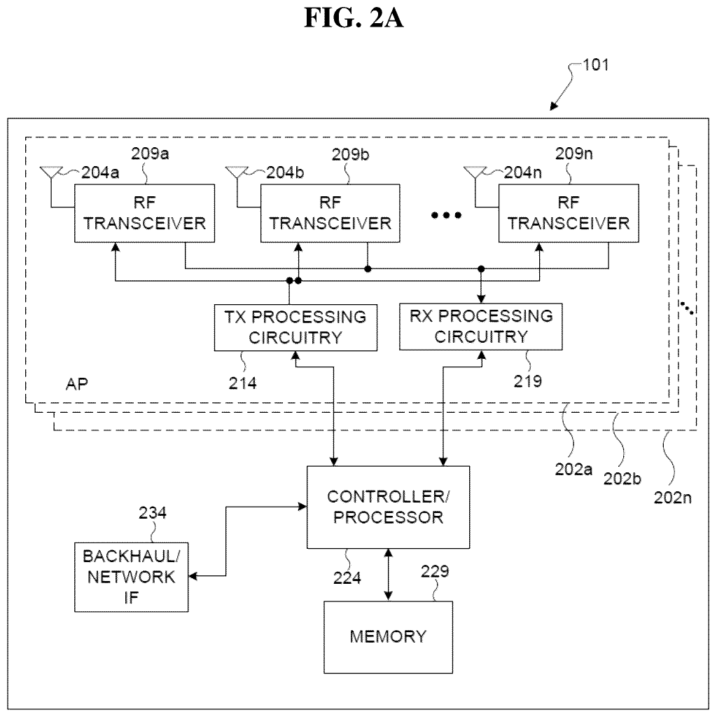

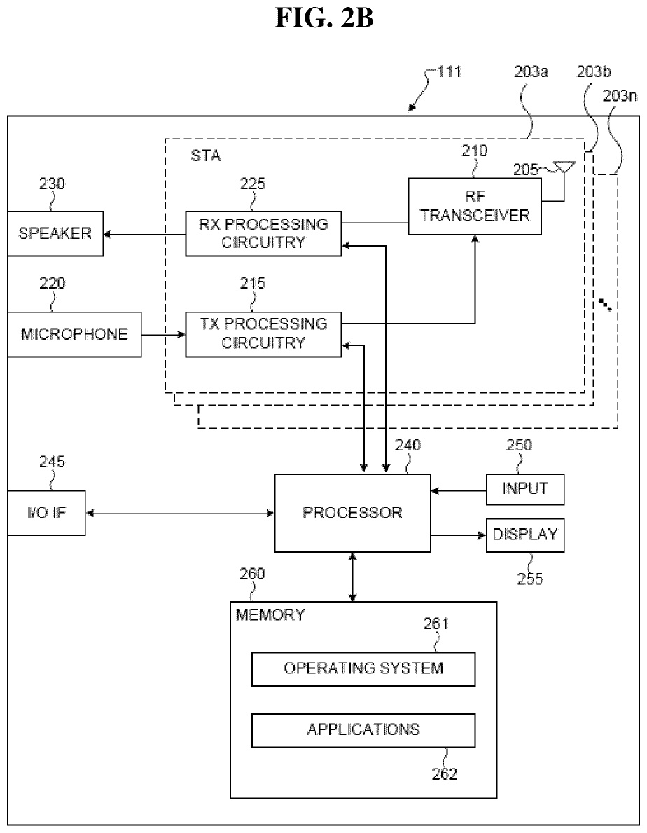

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

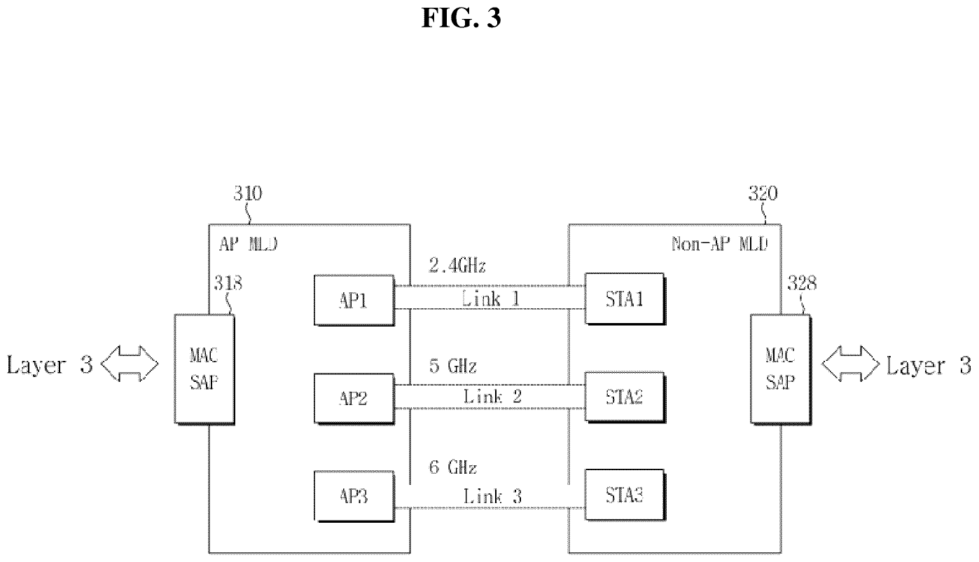

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.0, “Wireless LAN Medium Access Control (MAC) and Physical Layer (PHY) Specifications.

In a WLAN, there may be various scenarios where traffic can be routed in the same WLAN through an AP. An example can be that of extended reality applications (XR) among other types of applications.

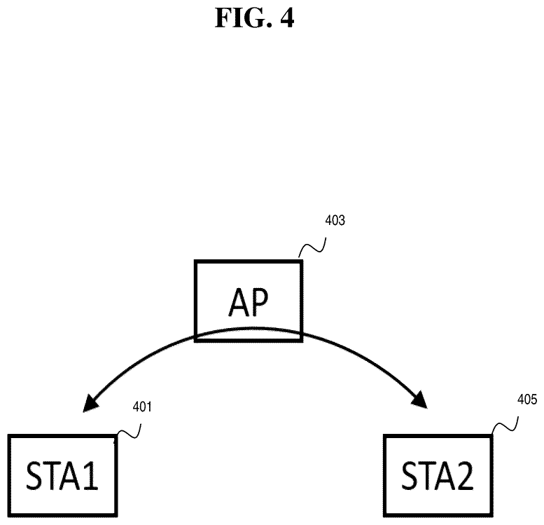

FIG. 4 illustrates end to end communication in a same basic service set (BSS) of a wireless network in accordance with an embodiment. FIG. 4 illustrates a first STA, STA1 401, communicating with a second STA, STA 2 405, through an AP 403. As illustrated, STA1, which can be a XR device, can be sending traffic to a compute device, STA2, that can be located in the same WLAN. The traffic between STA1 401 and STA2 405 may be routed through the AP 403. In such a scenario, there can be a need to setup a QoS for both the devices, STA1 and STA2. The information about the QoS requirement can be present at STA1. Thus, STA1 can setup a QoS for STA2. In some embodiments, an STA (e.g., STA1) can setup a QoS for itself as well as another STA (e.g., STA2). In some embodiments, if an AP triggers a second STA (e.g., STA2) to procure traffic for a stream whose QoS has been setup by a first STA (e.g., STA1), the second STA (e.g., STA2) may not be aware of the AP's intention and may send some other traffic that meets the trigger criteria. This can be a problem as the AP may not be able to meet the QoS requirements that it has agreed to during the setup process with the first STA (e.g., STA1). Accordingly, embodiments in accordance with this disclosure may include a trigger frame that has been designed to convey the AP's intention to STA2.

Continuing with the example illustrated in FIG. 4, STA1 401 which can be a XR device can be sending traffic to a compute device, STA2 403, that can be located in the same WLAN. In such a scenario, STA1 401 can know the end-to-end characteristic of the traffic. For example, STA1 401 can know the end-to-end delay tolerance. However, due to a lack of knowledge about the link between the AP 403 and STA2 405, STA1 401 may not be able to specify the characteristics of the downlink traffic flow between the AP 403 and the STA2 405. In the example where STA1 401 knows the end-to-end delay tolerance, STA1 401 may not be able to break it down for the two links, one between AP 403 and STA1 401 and the other between AP 403 and STA2 405. In such a scenario, a mechanism may be needed by which an STA can make a request for meeting its QoS requirements for the flow going within the WLAN.

Embodiments in accordance with this disclosure may provide a trigger frame design to request frames to meet a QoS requirement. The trigger frame can be transmitted by the AP to another other STA (e.g., STA2 in FIG. 4) to inform the STA about AP's intention to procure frames belonging to a particular stream for which QoS has been setup. In some embodiments, the trigger frame can carry information about which stream's frames the AP intends to procure from the STA. The trigger frame can include at least one or more of the information items as shown in Table 1.

TABLE 1

| Information | |
|---|---|
| item | Description |
| Indication of | An information item that can indicate the frames that can be transmitted in |
| what frames to | response to the trigger frame. In some embodiments, this can be an |
| send in | indication of the stream whose frames are being triggered. In such a case, |
| response | the triggered device can send the frames of the indicated stream only even |
| | if it has frames in the same category (e.g., AC, TID, among others) that are |
| | queued for transmission. This indication can enable to remove any |
| | ambiguity that can exist with respect to what type of frames can be |
| | transmitted in response to a particular frame. This can also enable the |
| | triggering entity to effectively meet the QoS requirement that it has agreed |
| | to meet. E.g., stream ID, service ID, SCS ID, TID, classifier mask, among |
| | others. This can also be an indication of what the preferred frames are. The |
| | allocation can be used by the STA to transmit frames that do not belong to |
| | the indicated type in addition to the ones that belong to the indicated type. |
| Recommendation | Triggering entity can make an indication if the triggered device is |
| type | recommended to follow the stream indication criteria strictly or if it is a |
| | soft indication and triggered device can choose to send other frames |
| | belonging to the same TID, AC, among others. |

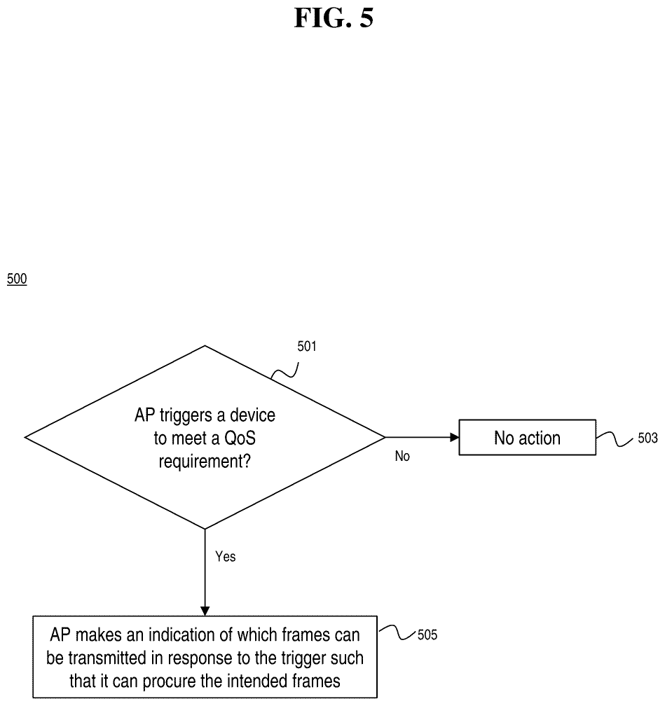

FIG. 5 illustrates a flow chart of an example process by an AP of transmitting a trigger frame to meet a QoS requirement in accordance with an embodiment. Although one or more operations are described or shown in particular sequential order, in other embodiments the operations may be rearranged in a different order, which may include performance of multiple operations in at least partially overlapping time periods. The flowchart depicted in FIG. 5 illustrates operations performed in AP, such as the AP illustrated in FIG. 4.

The process 500, in operation 501, the AP triggers a device to meet a QOS requirement. If in operation 501 the AP does not trigger a device to meet a QOS requirement the process proceeds to operation 503 and performs no action. If in operation 501 the AP does trigger a device to meet a QoS requirement, then the process proceeds to operation 505.

In operation 505 the AP makes an indication of which frames can be transmitted in response to the trigger such that it can procure the intended frames.

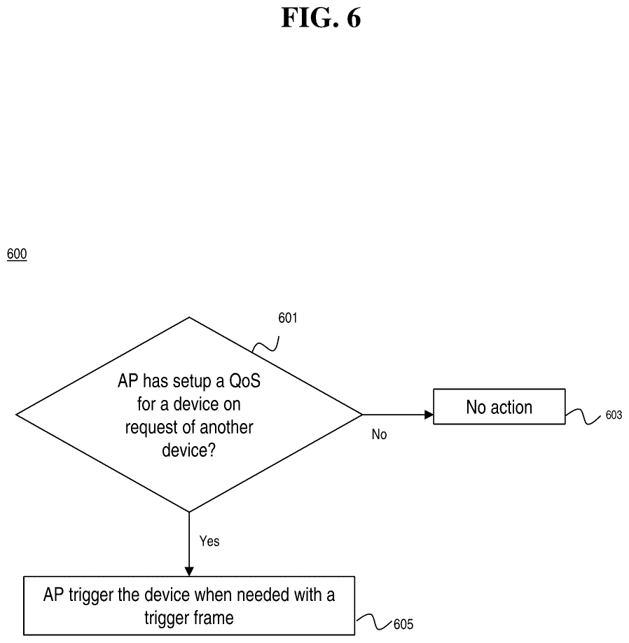

FIG. 6 illustrates a flow chart of an example process by an AP when a QoS has been setup for a device by another device in accordance with an embodiment. Although one or more operations are described or shown in particular sequential order, in other embodiments the operations may be rearranged in a different order, which may include performance of multiple operations in at least partially overlapping time periods. The flowchart depicted in FIG. 6 illustrates operations performed in AP, such as the AP illustrated in FIG. 4.

The process 600, in operation 601 the AP determines whether it has set up a QoS for a device on request of another device. If in operation 601 the AP determines that it has not set up a QoS for a device on request of another device, the process proceeds to operation 603 and performs no action. In operation 601, the AP determines that it has set up QoS for a device on request of another device the process proceeds to operation 605.

In operation 605 the AP triggers the device when needed with the trigger frame.

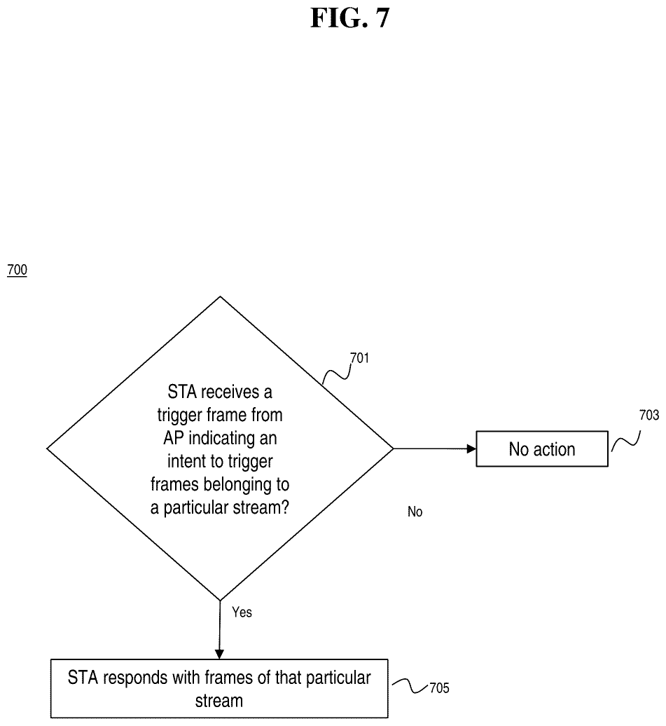

FIG. 7 illustrates a flow chart of an example process by an STA of receiving a trigger frame in accordance with an embodiment. Although one or more operations are described or shown in particular sequential order, in other embodiments the operations may be rearranged in a different order, which may include performance of multiple operations in at least partially overlapping time periods. The flowchart depicted in FIG. 7 illustrates operations performed in STA, such as the STA illustrated in FIG. 4.

The process 700, in operation 701, the STA determines whether it receives a trigger frame from an AP indicating an intent to trigger frames belonging to a particular stream. If in operation 701 the STA determines that it does not receive a trigger frame from the AP indicating an intent to trigger frames belonging to a particular stream, the process proceeds to operation 703 and performs no action. If in operation 701, if the STA determines that it does receive a trigger frame from the AP indicating an intent to trigger frames belonging to a particular stream, the process proceeds to operation 705.

In operation 705 the STA responds with frames of that particular stream.

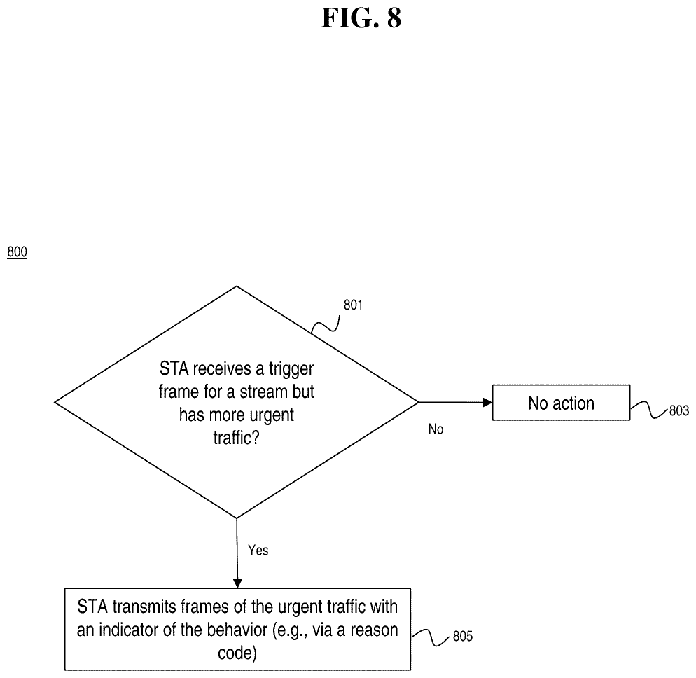

FIG. 8 illustrates a flow chart of an example process by an STA when the STA has more urgent traffic to send in accordance with an embodiment. Although one or more operations are described or shown in particular sequential order, in other embodiments the operations may be rearranged in a different order, which may include performance of multiple operations in at least partially overlapping time periods. The flowchart depicted in FIG. 8 illustrates operations performed in STA, such as the STA illustrated in FIG. 4.

The process 800, in operation 801, the STA determines whether it receives a trigger for a stream but has more urgent traffic. If in operation 801 the STA determines that it does not receive a trigger frame for a stream, the process proceeds to operation 803 and performs no action. If in operation 801, the STA determines that it does receive a trigger frame for a particular stream, but has more urgent traffic, the process proceeds to operation 805. In operation 805, the STA Transmits frames of the urgent traffic with an indicator of the behavior (e.g. reason code).

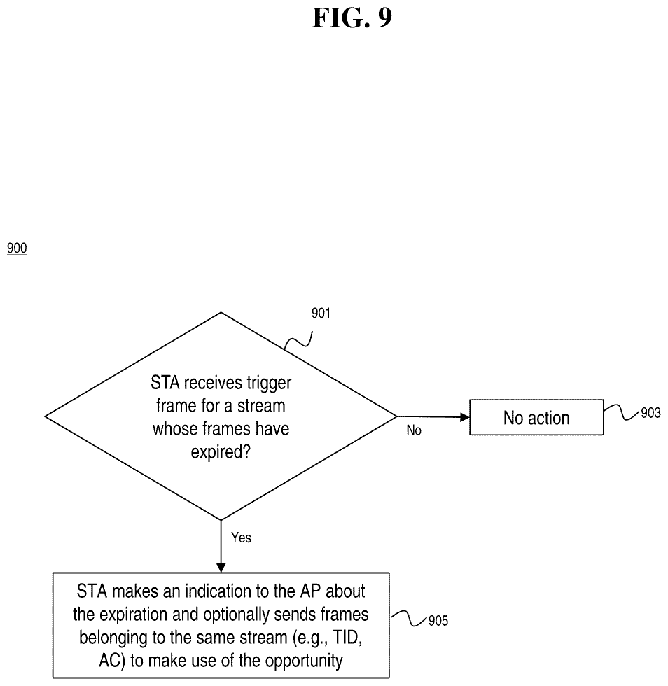

FIG. 9 illustrates a flow chart of an example process by an STA of receiving a trigger frame for streams whose frames have already expired. Although one or more operations are described or shown in a particular sequential order, in other embodiments the operations may be rearranged in a different order, which may include performance of multiple operations in at least partially overlapping time periods. The flowchart depicted in FIG. 9 illustrates operations performed in STA, such as the STA illustrated in FIG. 4.

The process 900, in operation 901, the STA determines whether it receives a trigger frame for a stream whose frames have already expired. If in operation 901 the STA determines that it does not receive a trigger frame for a stream whose frames have already expired the process proceeds to operation 903 and performs no action. If in operation 901 the STA determines that it does receive a trigger frame for a stream whose frames have already expired, the process proceeds to operation 905.

In operation 905 the STA makes an indication to the AP about the expiration and may optionally send frames belonging to the same stream (e.g., TID, AC, among other indicators) to make use of the opportunity.

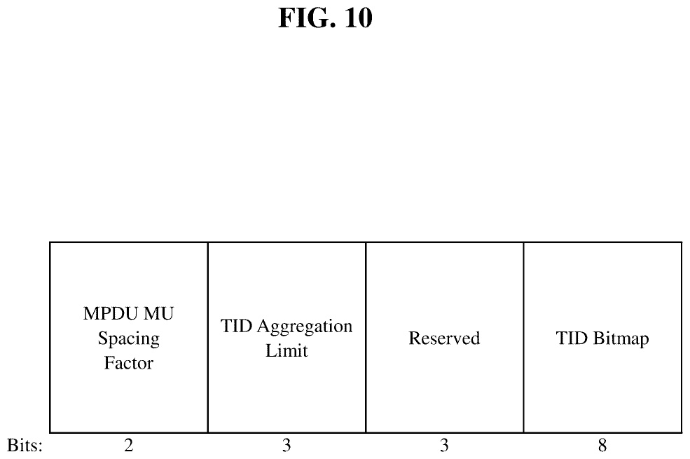

In some embodiments, the trigger frame can include the preferred indication (e.g., preferred TID/SCSID, among others). There can be a modified basic trigger frame format which can carry the indication. The various fields described herein with reference to FIGS. 10-17 may include the same or similar fields and the associated description may be omitted to avoid repetition.

In particular, FIG. 10 illustrates an example TID indication in a trigger frame with a modified trigger dependent user info subfield in accordance with an embodiment. The trigger frame may include medium access control protocol data unit (MPDU) multi-user (MU) spacing factor field, a traffic identifier (TID) aggregation limit field, a reserved field, and a TID bitmap.

The MPDU MU spacing factor field may set a value by which a minimum MPDU start spacing is multiplied.

The TID aggregation limit field provides information regarding a maximum number of TIDs that can be aggregated by a STA in a responding PPDU.

The reserved field may be reserved.

The TID bitmap field may indicate the TIDs which can be transmitted in response to the trigger frame. A value of 1 in the bit position n of the TID bitmap can indicate to the STA that the frames corresponding to TID n can be preferred to be transmitted. A value of 0 in the bit position n of the TID bitmap can indicate to the STA that the frames corresponding to TID n are not preferred to be transmitted. The values of 1 and 0 are only examples and the indication can be flipped as well (e.g., 1 can imply that they are not preferred and 0 can imply that they are preferred).

In some embodiments, the trigger frame can include a list of TIDs which are preferred TIDs. In some embodiments, the trigger frame can carry a TID field which can indicate the lowest or highest TID for the frame that can be transmitted.

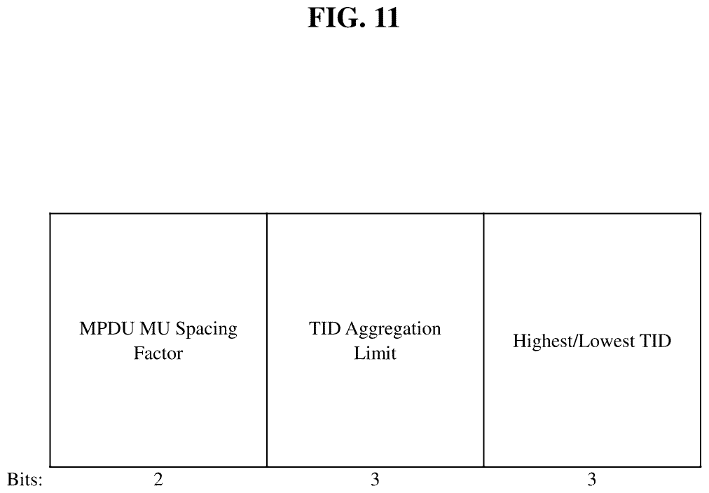

As described herein with reference to FIGS. 11, 13, 14, 15, 16, 17 and 18, the description of certain fields is omitted as it may be the same as fields that have already been described herein, including the MPDU MU Spacing Factor field, and the TID Aggregation Limit field as described with reference to FIG. 10.

FIG. 11 illustrates a trigger frame with a preferred TID indication bit in accordance with an embodiment. The trigger frame includes a MPDU Spacing Factor field, a TID Aggregation Limit field, and a Highest/lowest TID field. The Highest/lowest TID field can indicate the lowest TID or highest TID for the preferred frame that can be transmitted by a STA that receives the trigger frame.

In some embodiments, there can be an indication in the trigger frame (e.g., a bit/reuse of a reserved bit) which can take a value (e.g., 1) to indicate that the trigger dependent user info subfield is a modified trigger dependent user info subfield.

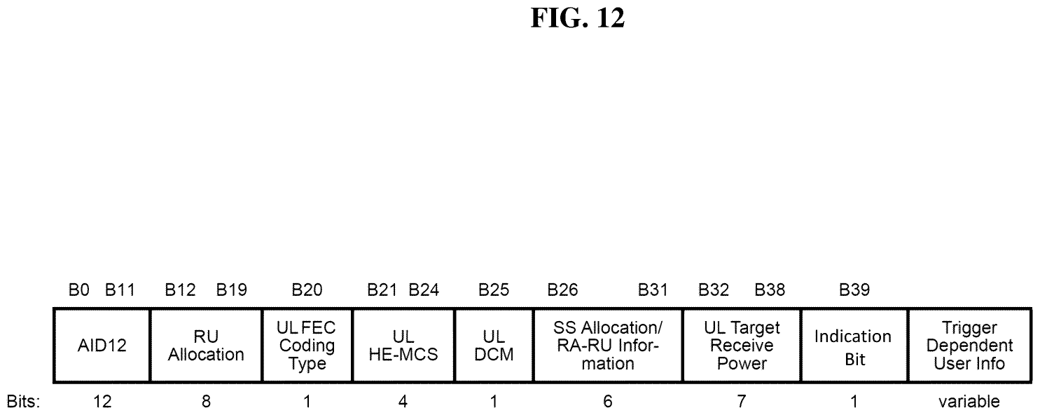

FIG. 12 illustrates a trigger frame with an indication of presence of modified user info field in accordance with an embodiment. The trigger frame includes an AID12 field, an RU allocation field, a UL FEC Coding Type field, a UL HE-MCS field, a UL DCM field, a SS Allocation/RA-RU Information field, a UL Target Receive Power field, an Indication Bit field, and a Trigger Dependent User Info field.

The AID 12 field can include an association identifier information of the trigger frame and may set the least significant 12 bits of the AID of the STA for which the user info field is intended. The RU allocation field can include receiver unit allocation information and may set the RU allocation used by a PPDU of the STA identified by the AID12 field. The upper layers forward error correction (UL FEC) coding type field can include information for obtaining error control in a data transmission. The upper layer high-efficiency modulation coding scheme (UL HE-MCS) field can include information regarding a data rate of a wireless connection. The UL dual carrier modulation (DCM) field can include DCM information of a solicited PPDU. The SS Allocation/RA-RU Information field can include a set of spatial streams of a PPDU response of the STA identified by the AID12 subfield. The UL Target Receive power field can include target receive power information of a PPDU response of the STA identified by the AID12 field.

The Indication Bit field can take a value of 1 to indicate that the trigger frame includes information on preferred frames to send. The indication bit can take a value of 0 to indicate that the trigger frame does not include information on preferred frames to send. The Triggered Dependent User Info field can provide data that details the settings and parameters needed by each individual device that is being triggered to transmit data.

In some embodiments, a trigger type subfield can take a value to indicate that the trigger frame carries an indication of a preference on what type of frames can be transmitted in response.

Table 2 illustrates a trigger type subfield encoding in accordance with an embodiment.

TABLE 2

| Trigger Type | |
|---|---|
| subfield value | Trigger frame variant |
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NFRP) |
| 8 | Preference indication trigger frame |
| 9-15 | Reserved |

In some embodiments, the trigger frame can include a TID field which can indicate the TID of the frames that can be transmitted.

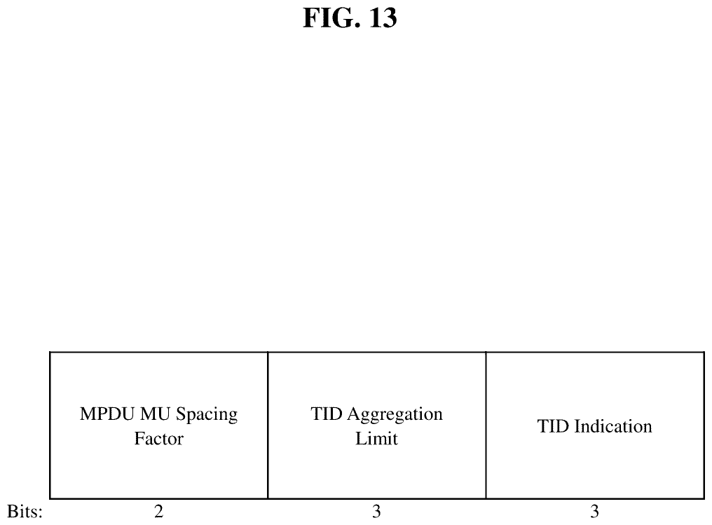

FIG. 13 illustrates a trigger frame with a TID indication in a modified trigger dependent user info subfield in accordance with an embodiment. The trigger frames includes an MPDU MU Spacing Factor field, a TID Aggregation Limit field, and a TID Indication field.

The TID Indication field can indicate the TID of the frames that can be transmitted.

In some embodiments, the trigger frame can include a stream classification service identifier (SCSID) indication (either a single SCSID or a list of SCSID). In some embodiments, the trigger frame can include an SCSID field which can indicate the SCSID for which the frames can be transmitted.

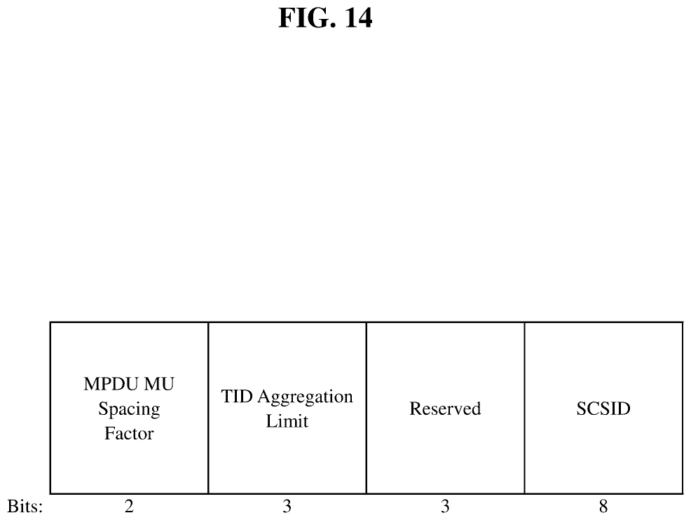

FIG. 14 illustrates a trigger frame that includes a SCSID in a modified trigger-dependent user info field in accordance with an embodiment. The trigger frame can include an MPDU MU Spacing Factor field, a TID Aggregation Limit field, a Reserved field, and a SCSID field. The Reserved field may be reserved. The SCSID field can indicate the SCSID for which the frames can be transmitted.

In some embodiments, the trigger frame can include a list of SCSIDs which can indicate the list of SCSIDs for which the frames can be transmitted. The count subfield can indicate the number of SCSIDs present in the list.

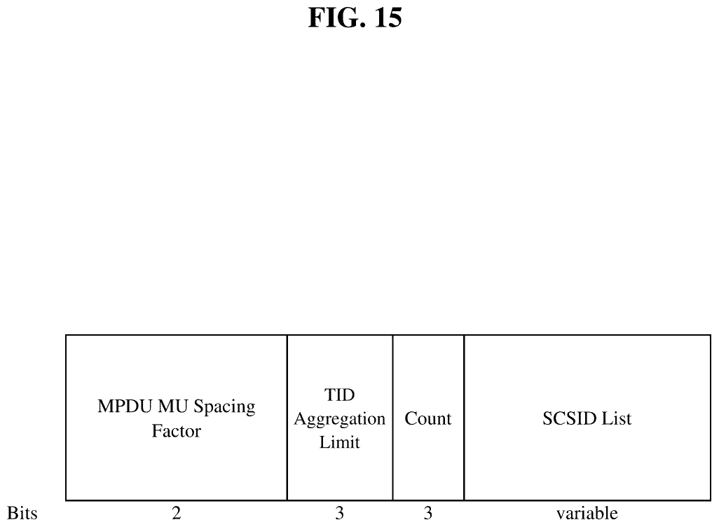

FIG. 15 illustrates a trigger frame that includes an SCSID indication in modified trigger dependent user info subfield in accordance with an embodiment. The trigger frame includes an MPDU MU Spacing Factor field, a TID Aggregation Limit field, a Count field, and a SCSID List field. The SCSID List field can include a list of SCSIDs which can indicate the list of SCSIDs for which the frames can be transmitted. The Count field can indicate the number of SCSIDs present in the list.

In some embodiments, the TID and SCSID indication can be made using the same modified trigger dependent user info subfield.

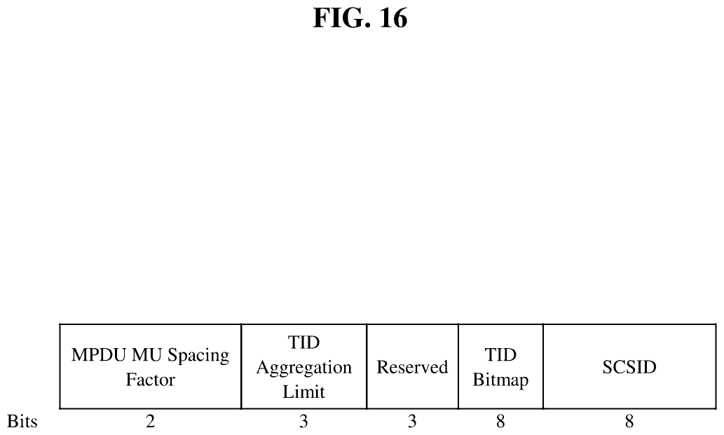

FIG. 16 illustrates a trigger frame that includes an SCSID and TID indication in a modified trigger dependent user info subfield in accordance with an embodiment. The trigger frame includes an MPDU MU Spacing Factor field, a TID Aggregation Limit field, a Reserved field, a TID Bitmap field, and a SCSID field.

The TID bitmap field may indicate the TIDs which can be transmitted in response to the trigger frame. A value of 1 in the bit position n of the TID bitmap can indicate to the STA that the frames corresponding to TID n can be preferred to be transmitted. A value of 0 in the bit position n of the TID bitmap can indicate to the STA that the frames corresponding to TID n are not preferred to be transmitted. The values of 1 and 0 are only examples and the indication can be flipped as well (e.g., 1 can imply that they are not preferred and 0 can imply that they are preferred). The SCSID field can indicate the SCSID for which the frames can be transmitted.

In some embodiments, there can be a second indication bit that can take a predetermined value (e.g., 1) to indicate whether the modified trigger dependent user info subfield carries TID bitmap and to another predetermined value (e.g., 0) to indicate whether the modified trigger dependent user info subfield carries an SCSID.

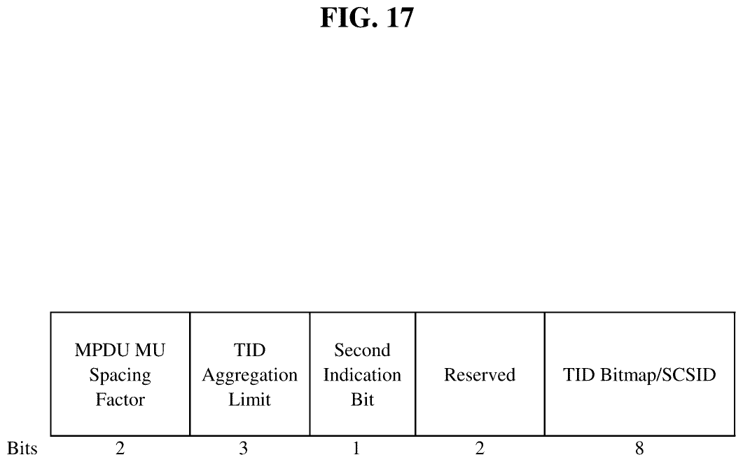

FIG. 17 illustrates a trigger frame that includes a field used to indicate SCSID and TID an in accordance with an embodiment. The trigger frame includes an MPDU MU Spacing Factor field, a TID Aggregation Limit field, a Second Indication Bit field, a Reserved field, and a TID Bitmap/SCSID field. The Second Indication bit field can take a predetermined value (e.g., 1) to indicate whether the modified trigger dependent user info subfield carries a TID bitmap and to another predetermined value (e.g., 0) to indicate whether the modified trigger dependent user info subfield carries an SCSID. An indication similar to that illustrated in FIG. 17 can be used to indicate presence of a modified trigger dependent user info subfield in accordance with the several examples illustrated in FIG. 10-16 herein.

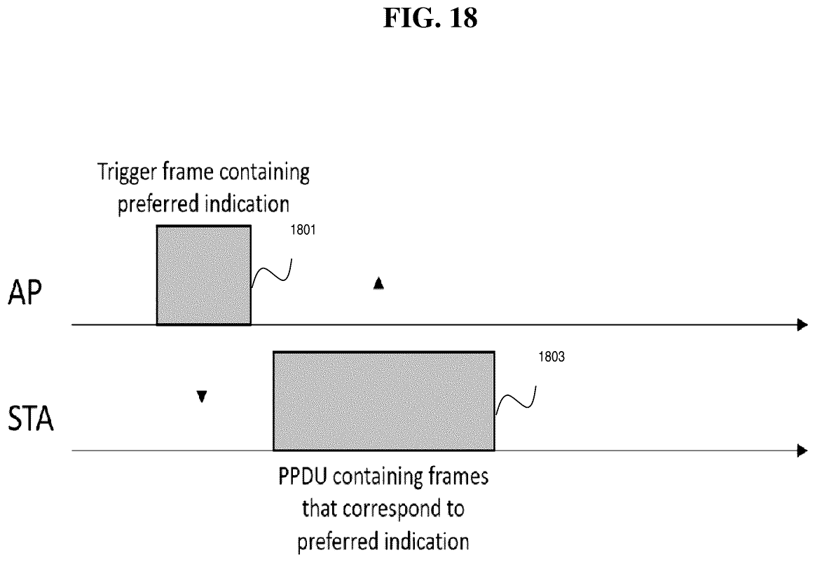

FIG. 18 illustrates an example for triggering based on preferred indication in accordance with an embodiment. In particular, FIG. 18 illustrates communication between an AP and an STA. The AP transmits to the STA a trigger frame 1801 that includes a preferred indication. In some embodiments, the AP can indicate the preferred TID/SCSID(s) in the trigger frame 1801. The STA can receive the trigger frame and transmit the frames within a PPDU 1803 that correspond to the TID/SCSID(s) indicated in the trigger frame.

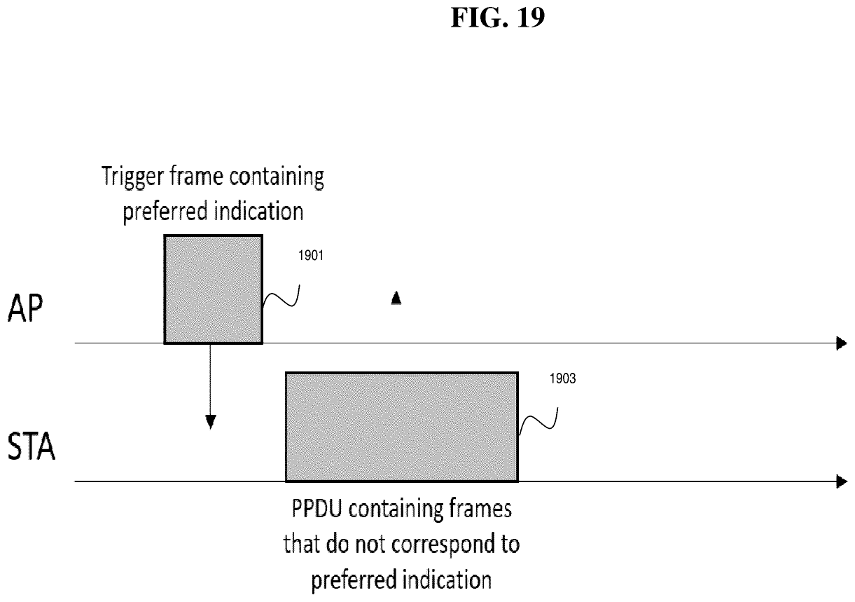

FIG. 19 illustrates an example for triggering based on preferred indication in accordance with an embodiment. As illustrated, the AP is communicating with an STA. The AP transmits a trigger frame 1901 that includes a preferred indication. The STA may not have frames that correspond to the preferred TID/SCSID or may have more urgent frames of other TID/SCSID. The STA transmits frames 1903 that do not correspond to the preferred indication in response to the trigger frame 1901.

In some embodiments, the STA may not have any frames that correspond to the preferred TID/SCSID. The STA may not send any PPDU in response to the trigger frame

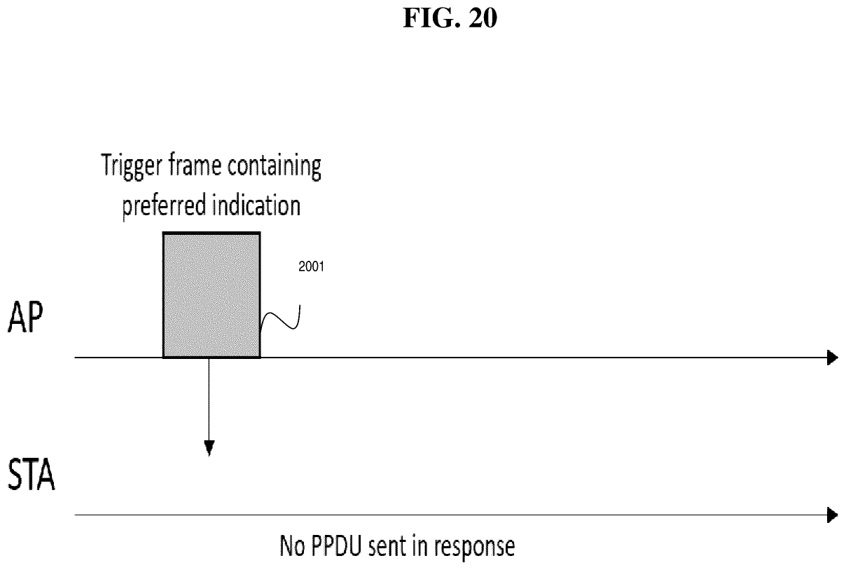

FIG. 20 illustrates an example for triggering based on preferred indication in accordance with an embodiment. The AP transmits a trigger frame 2001 that includes a preferred indication (e.g., TID or SCS ID among other indicators) to the STA. The STA may not have any frames that correspond to the preferred indication (e.g., TID or SCSID), and thus the STA does not send any PPDU in response to the trigger frame 2001.

In some embodiments, an AP that supports the transmission of such triggered frames can advertise the capability in one or more frames that it transmits (e.g., management frames such as beacons, probe responses, (re) association responses, among others). In some embodiments, there can be a bit that can take a predetermined value (e.g., 1) to indicate the support and to another predetermined value (e.g., 0) to indicate lack of the support.

In some embodiments, a STA that supports the reception of such triggered frames and corresponding response procedure can advertise the capability in one or more frames that it transmits (e.g., probe request frames, (Re) association request frames, among others). In some embodiments, there can be a bit that can take a predetermined value (e.g., 1) to indicate the support and to another predetermined value (e.g., 0) to indicate lack of the support.

In some embodiments, a frame may be sent by a STA instead of an AP. For example, a STA transmitting to a peer STA. In some embodiments, a frame may be sent by an AP to another AP (e.g., when sharing time and/or frequency resources).

In some embodiments, an STA can transmit a QoS characteristics information element (IE) with end-to-end characteristics of the traffic. In some embodiments, when an STA transmits the QoS characteristics IE, it can include the end-to-end delay and the other traffic characteristics can also be for each end.

In some embodiments, an STA can transmit a QoS characteristics element for its uplink that can carry the end-to-end delay tolerance and other traffic characteristics. An STA (e.g., STA1) can also generate a QoS characteristics for another STA's (e.g., STA2's) uplink indicating the end to end delay tolerance and other traffic characteristics.

In some embodiments, the request can be made through SCS request and response framework. In the request message, the STA can indicate that the QoS requirements are for an end to end case. For example, the traffic entirely flows within the WLAN. This can enable the AP to treat the request differently from the legacy QoS request (e.g., when the STA makes a DL and UL QOS request for itself).

In some embodiments, based on the indication of an STA (e.g., STA1) for the uplink end to end QoS of its own flow going to another STA (e.g., STA2) and the other STA's flow (e.g., STA2's flow) coming to itself, AP can compute the downlink QoS. In some embodiments, the AP may or may not inform the individual STAs about the downlink QoS.

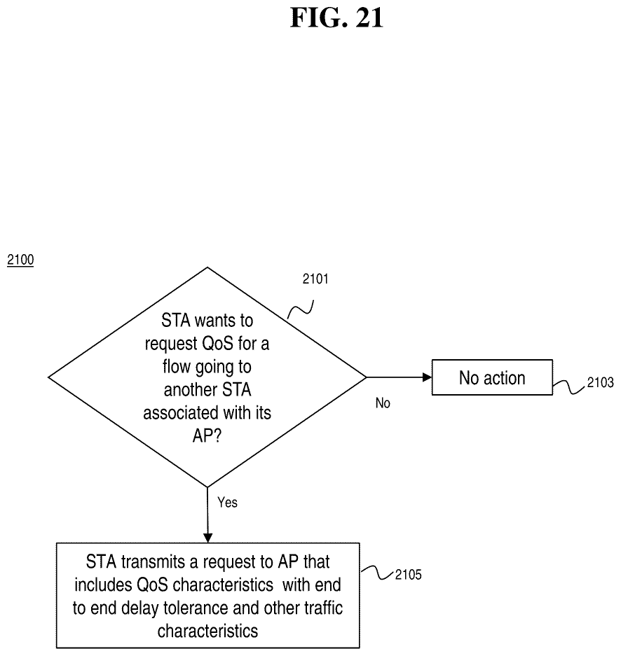

FIG. 21 illustrates a flow chart of an example process by an STA for transmitting a QoS information element to an AP in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 9 illustrates operations performed in STA, such as the STA illustrated in FIG. 4.

The process 2100, in operation 2101, the STA determines whether the STA wants to request QoS for a flow going to another STA associated with the STA's AP. If in operation 2101, the STA determines that it does not want to request QoS for the flow going to another STA associated with the STA's AP, the process proceeds to operation 2103 and performs no action.

If in operation, the STA determines that it does want to request QoS for the flow going to another STA associated with the STA's AP, the process proceeds to operation 2105.

In operation 2105, the STA transmits a request to the AP that includes a QoS characteristics element with end to end delay tolerance and other traffic characteristics.

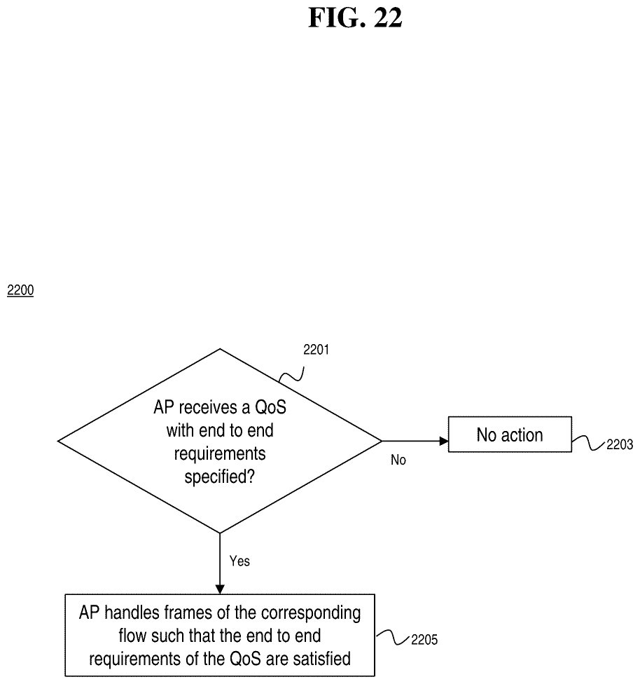

FIG. 22 illustrates a flow chart of an example process by an AP for setting up a QoS information element from an STA in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 9 illustrates operations performed in AP, such as the AP illustrated in FIG. 4.

The process 2200, in operation 2201, the AP determines whether it receives a QoS with end to end requirements specified. If in operation 2201, the AP determines it does not receive a QoS with end to end requirements specified, the process proceeds to operation 2203 and performs no action. If in operation 2201, the AP determines it does receive a QoS with end to end requirements specified, the process proceeds to operation 2205.

In operation 2205, the AP handles frames of the corresponding flow such that the end to end requirements of the QoS are satisfied.

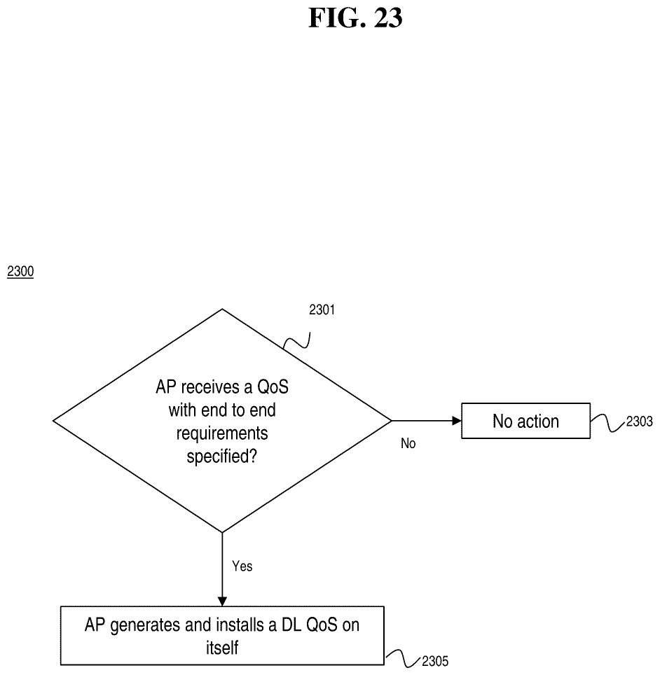

FIG. 23 illustrates a flow chart of an example process by an AP for a downlink QoS installation procedure in accordance with an embodiment. Although one or more operations are described or shown in particular sequential order, in other embodiments the operations may be rearranged in a different order, which may include performance of multiple operations in at least partially overlapping time periods. The flowchart depicted in FIG. 9 illustrates operations performed in AP, such as the AP illustrated in FIG. 4.

The process 2300, in operation 2301, the AP determines whether it receives a QoS with end to end requirements specified. If in operation 2301, the AP it does not receive a QoS with end to end requirements specified, the process proceeds to operation 2303 and performs no action. If in operation 2301, the AP determines that it does receive a QoS with end to end requirements specified, the process proceeds to operation 2305.

In operation 2305, the AP generates and installs a downlink (DL) QoS on itself.

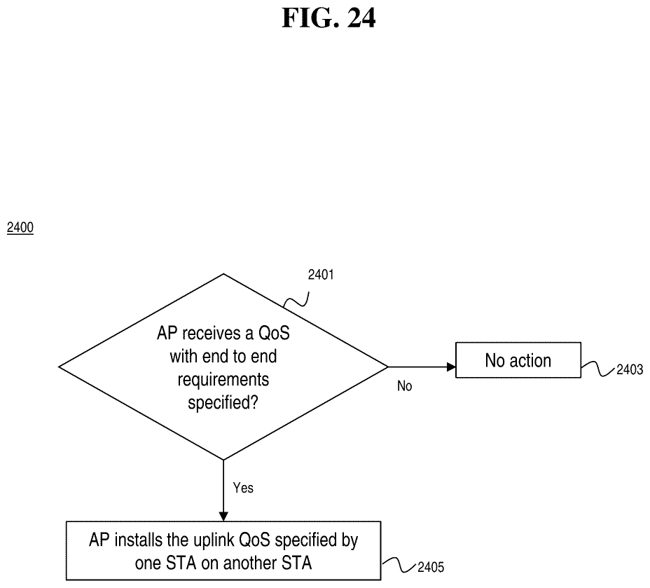

FIG. 24 illustrates a flow chart of an example process by an AP for uplink QoS installation in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 9 illustrates operations performed in AP, such as the AP illustrated in FIG. 4.

The process 2400, in operation 2401, the AP determines whether it receives a QoS with end to end requirements specified. If in operation 2401, the AP determines that it does not receive a QoS with end to end requirements specified, the process proceeds to operation 2403 and performs no action. If in operation 2401, the AP determines that it does receive a QoS with end to end requirements specified, the process proceeds to operation 2405.

In operation 2405, the AP installs the uplink QoS specified by one STA on another STA.

In some embodiments, when making an indication about the direction, an STA can include one or more of the information items as shown in Table 3.

TABLE 3

| Information | |
|---|---|
| item | Description |
| End to end | An information item to indicate that the flow is end to end. e.g., a bit |
| indication | that can take a predetermined value to make the indication |
| End device | An information item to indicate the end device for which the request is |
| indication | being made. e.g., device ID, MAC address, AID, among others. |
| End device QoS | An information item that can indicate if the specified QoS is for the end |
| indication | device or for itself. e.g., a bit that can take a predetermined value to |
| | make the indication, end device identifier such as MAC address, AID, |
| | among others. |

The above QoS characteristics IEs can be exchanged via the SCS framework.

An example interpretation of some of the fields of the QoS characteristic element can be as follows.

The direction subfield encoding of the control info field of the QoS characteristic element can take a value of 3 to indicate that the traffic is end to end.

Table 4 illustrates a direction subfield encoding in accordance with an embodiment.

TABLE 4

| Direction | Usage |
|---|---|
| 0 | Uplink, defined as follows: |
| | MAC Service Data Units (MSDUs) or Aggregate |
| | MSDUs (A-MSDUs) are sent from the non-AP STA to |
| | the AP. |
| 1 | Downlink, defined as follows: |
| | MSDUs or A-MSDUs are sent from the AP to the non- |
| | AP STA. |
| 2 | Direct link (MSDUs or A-MSDUs are sent over a peer-to-peer |
| | link). |
| 3 | End to End topology: |
| | MSDUs or A-MSDUs are sent from the non-AP STA |
| | to another non-AP STA via the AP |

In some embodiments, the Delay Bound field can include an unsigned integer that specifies the maximum amount of time, in microseconds, targeted to transport an MSDU or A-MSDU belonging to the traffic flow described by this element. In some embodiments, the time may be measured between the time marking the arrival of the MSDU, or the first MSDU of the MSDUs constituting an A-MSDU, at the local MAC sublayer from the local MAC SAP which can be STA1 and the time of completion of the successful (re) transmission of the MPDU containing the MSDU to the destination which can be the other STA (e.g., STA2). The completion time of the MSDU or A-MSDU transmission may include the corresponding acknowledgment frame transmission time, if present.

In some embodiments, an MSDU Lifetime field can include an unsigned integer that specifies the maximum amount of time, in milliseconds, since the arrival of the MSDU at the MAC data service interface beyond which the MSDU is not useful even if received by the receiver which can be the other STA (e.g., STA2).

In some embodiments, the MSDU Delivery Ratio subfield can specify the percentage of the MSDUs that are expected to be delivered successfully to the other STA (e.g., STA2) computed based on the total number of MSDUs indicated by MSDU Count Exponent subfield.

In some embodiments, if the Delay Bound field included in the QoS Characteristics element is nonzero, an MSDU can be considered delivered successfully for the purpose of the computation of the MSDU Delivery Ratio value only if the MSDU is delivered within the indicated delay bound to another STA (e.g., STA2).

In some embodiments, an STA can transmit an SCS request that can include a QoS characteristic element with certain fields whose values can be set as per the interpretation above.

In some embodiments, the SCS request can include an intra-access category priority element on relative priorities of streams within an AC when being transmitted on the downlink.

In some embodiments, the SCS request can include traffic classification (TCLAS) element along with TCLAS processing element to identify the MSDUs coming from the STA that belong to the particular TS.

Embodiments in accordance with this disclosure may provide a trigger frame design to request frames to meet a QoS requirement, whereby the trigger frame can be transmitted by the AP to another other STA to inform the STA about AP's intention to procure frames belonging to a particular stream for which QoS has been setup. In some embodiments, the trigger frame can carry information about which stream's frames the AP intends to procure from the STA, which can help meet the QOS requirements for traffic within the wireless network, improving communication between devices within the network.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the inventive subject matter. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) in a wireless network, the AP comprising:
a memory; and
a processor coupled to the memory, the processor configured to:
transmit, to a station (STA), a first frame that indicates a preferred frame for the STA to transmit in response to the first frame; and
receive, from the STA, a second frame that is the preferred frame in response to the first frame.

2. The AP of claim 1, wherein the preferred frame belongs to a particular stream associated with an established quality of service (QOS).

3. The AP of claim 2, wherein the QoS is established for the STA based on a request received from another STA.

4. The AP of claim 1, wherein the preferred frame is associated with a traffic identifier (TID) or a stream classification service identifier.

5. The AP of claim 1, wherein the preferred frame is associated with a traffic identifier (TID) that satisfies a lowest TID requirement or a highest TID requirement for the preferred frame.

6. The AP of claim 1, wherein the first frame includes information indicating that the first frame includes information on the preferred frames for the STA to transmit in response to the first frame.

7. The AP of claim 1, wherein the first frame includes information indicating whether the first frame includes a traffic identifier or a stream classification service identifier.

8. The AP of claim 1, wherein the processor is further configured to:
receive, from the STA, a third frame that includes a QoS information element that includes information associated with a delay tolerance for traffic between the STA and another STA associated with the AP; and
wherein the first frame is transmitted to meet the delay tolerance.

9. A station (STA) in a wireless network, the STA comprising:
a memory; and
a processor coupled to the memory, the processor configured to:
receive, from an access point (AP), a first frame that indicates a preferred frame for the STA to transmit in response to the first frame; and
transmit, to the AP, a second frame that is the preferred frame in response to the first frame.

10. The STA of claim 9, wherein the preferred frame belongs to a particular stream associated with an established quality of service (QOS).

11. The STA of claim 10, wherein the QoS is established for the STA based on a request transmitted to the AP from another STA.

12. The STA of claim 9, wherein the preferred frame is associated with a traffic identifier (TID) or a stream classification service identifier.

13. The STA of claim 9, wherein the preferred frame is associated with a traffic identifier (TID) that satisfies a lowest TID requirement or a highest TID requirement for the preferred frame.

14. The STA of claim 9, wherein the first frame includes information indicating that the first frame includes information on the preferred frames for the STA to transmit in response to the first frame.

15. The STA of claim 9, wherein the first frame includes information indicating whether the first frame includes a traffic identifier or a stream classification service identifier.

16. The STA of claim 9, wherein the processor is further configured to:
transmit, to the AP, a third frame that includes a QoS information element that includes information associated with a delay tolerance for traffic between the STA and another STA associated with the AP; and
wherein the second frame is transmitted to meet the delay tolerance.

17. A computer-implemented method for wireless communication by an access point (AP) in a wireless network, comprising:
transmitting, to a station (STA), a first frame that indicates a preferred frame for the STA to transmit in response to the first frame; and
receiving, from the STA, a second frame that is the preferred frame in response to the first frame.

18. The computer-implemented method of claim 17, wherein the preferred frame belongs to a particular stream associated with an established quality of service (QOS).

19. The computer-implemented method of claim 18, wherein the QoS is established for the STA based on a request received from another STA.

20. The computer-implemented method of claim 17, wherein the preferred frame is associated with a traffic identifier (TID) or a stream classification service identifier.
